(19) United States
(12) Patent Application Publication
(10) Pub. No.: US 2003/0218968 A1
(43) Pub. Date: Nov. 27, 2003

(54) Vacuum-resistant compact disc

(75) Inventors: Chia-Wen Hsu, Taipei (TW); Li-Chuan Chiu, Taoyuan (TW)

Correspondence Address: Richard P. Berg, Esq., c/o LADAS & PARRY, 5670 Wilshire Boulevard, Suite 2100, Los Angeles, CA, 90036-5679, US

(73) Assignee: Daxon Technology Inc.

(21) Appl. No.: 10/442,309

(22) Filed: May 19, 2003

(30) Foreign Application Priority Data
May 22, 2002 (TW) 91207347

(51) Int. Cl. G11B 3/70; G11B 5/84; G11B 7/26

(52) U.S. Cl. 369/282

(57) ABSTRACT

A disc with a plurality of rough passages. The rough passages are arranged on the top surface around a through hole of the disc, or on the ring protrusion of the readable under-surface. The rough passages are formed by printed ink or by punching the surface of the disc, and reduce vacuum adhesion between disks when stacked.

### BACKGROUND OF THE INVENTION

1. Field of the Invention

The present invention relates to an unfinished compact disc, and in particular to a compact disc able to prevent vacuum adhesion.

2. Description of the Related Art

Compact discs (CDs) or digital video discs (DVDs) are popular optical storage devices used to store multimedia data or backup files.

FIG. 1A is a schematic top view of a conventional CD, and FIG. 1B is a cross section of line a-a. In FIGS. 1A and 1B, the conventional CD is a plastic disc 10 made by injection molding. The disc 10 has a central hole 11, a top surface 15 and a readable under-surface 13, which the laser bean contacts. The top surface of the disc 10 is provided for coating, gluing, and printing. The disc 10 has a recording area 131 between the central hole 11 and the outer edge of the disc 10. There is an annular data-recording layer 14 disposed in the recording area 131. The disc 10 also has a ring protrusion 132 disposed on the readable under-surface around the central hole 11 at intervals. In FIG. 1B, it is next to the recording area 131. The ring protrusion 132 has a predetermined thickness and width to prevent vacuum adhesion. The ring protrusion 132 of a disc contacts the top surface of the next when discs are stacked together.

In FIG. 1C, after discs 10 are formed, they are stacked on a base 17 (about 100 discs), forming a spindle of discs. The unfinished discs 10 are then recorded or printed. FIG. 1D is a cross section of two conventional compact discs in middle area of the spindle. The unfinished disc 10a has a ring protrusion 132a, however, the portion near the outer edge is deformed because of gravity and plastic deformation. The portions around the through hole and the outer edge are warped and contact the top surface of the next disc. Thus, the disc 10b adheres to the disc 10a because of the vacuum between the readable under-surface 13 of the disc 10a and the top surface 15b of the disc lob. For this reason, when a robot arm of a machine retrieves a disc from the spindle, two or more discs may adhere, causing a crash or damaging the machine, requiring process time to repair the machine, and raising the running cost.

### SUMMARY OF THE INVENTION

Accordingly, an object of the invention is to provide an unfinished compact disc able to avoid vacuum adhesion.

The present invention provides a vacuum-resistant compact disc having a through hole and a top surface. It further comprises a central area with a plurality of rough passages around the through hole on the top surface.

According to the preferred embodiment, the vacuum-resistant compact disc of the invention is made by injection molding. Furthermore, the rough passages in the central area are radially disposed on the top surface, formed by punching or printed ink mesh.

The present invention provides a vacuum-resistant compact disc having a through hole and a readable under-surface. The compact disc further comprises a central area with a ring protrusion disposed on the readable under-surface and separated from the through hole by a predetermined interval. A plurality of rough passages is disposed on the ring protrusion.

According to the second embodiment, the vacuum-resistant compact disc of the invention is made by injection molding. Moreover, the rough passages in the central area are radially disposed on the top surface, formed by punching or printed ink mesh.

A detailed description is given in the following embodiments with reference to the accompanying drawings.

### BRIEF DESCRIPTION OF THE DRAWINGS

The present invention can be more fully understood by reading the subsequent detailed description and examples with references made to the accompanying drawings, wherein:

FIG. 1A is a schematic top view of a conventional compact disc;

FIG. 1B is a cross section of line a-a in FIG. 1A;

FIG. 1C is a schematic view of a spindle of conventional compact discs stacked together;

FIG. 1D is a cross section of two conventional compact discs from FIG. 1C;

FIG. 2 is a schematic top view of a compact disc of the invention; and

FIG. 3 is a schematic bottom view of a compact disc in the second embodiment of the invention.

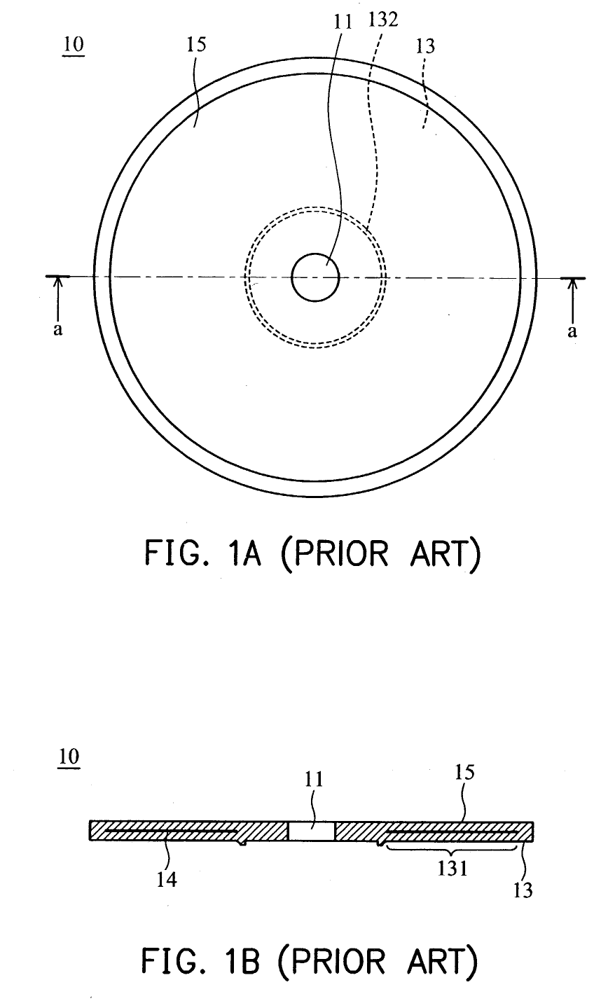

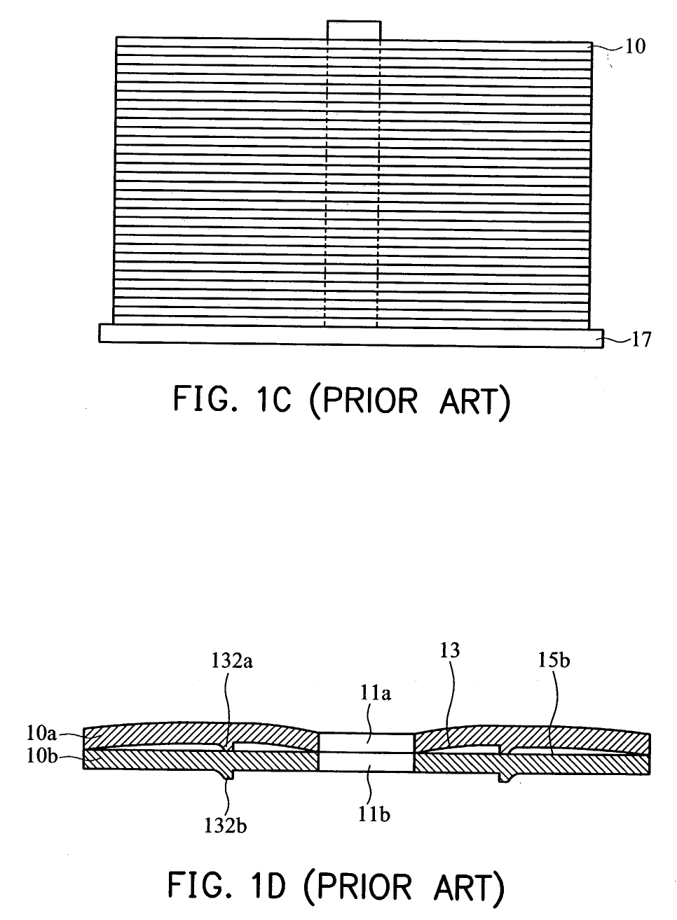

### DETAILED DESCRIPTION OF THE INVENTION

First Embodiment

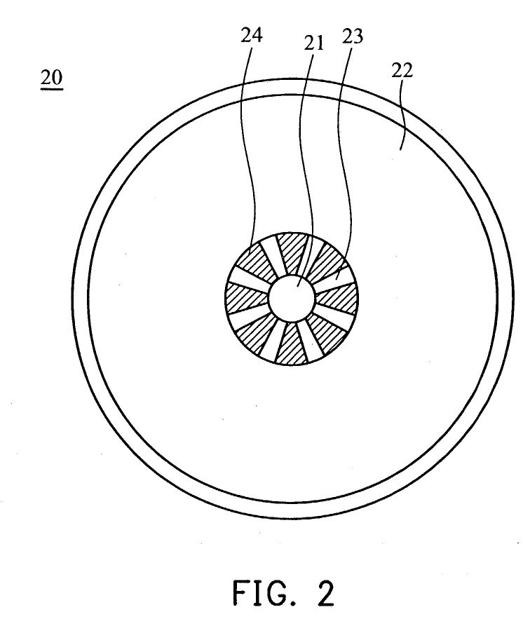

FIG. 2 shows an unfinished compact disc 20 made by injection molding, of engineering plastic such as Acrylic, PolyCarbonate (PC) or ABS. The fabrication process of the compact disc 20 includes producing a stamper according to a first mold, injecting plastic into the stamper and forming a compact disc 20. At this time, the disc is unfinished. The surface of the disc is not coated, glued, and printed.

The disc 20 has a central hole 21, a top surface and a readable under-surface, which the laser bean contacts. The top surface of the disc 20 is divided into two areas, the central area 23 and the printing area 22. The printing area 22 of the disc 20 will be coated, glued, and printed to finish the disc. The central area 23 is an annular area between the printing area 22 and the through hole 21 on the top surface with a plurality of rough passages 24. The readable under-surface of the disc 20 is also divided into two areas, a central area and a read/write area. The read/write area is for reading or saving data by a laser beam.

In FIG. 2, the rough passages 24 are radially disposed in the central area 23. Accordingly, when the discs of the invention are stacked in a spindle, they will not adhere to each other because of the rough passages 24. The rough passages 24 reduce vacuum between the readable under-surface of the upper disc and the top surface of the lower disc. Furthermore, the rough passages can be a plurality of annular rough areas. As well, the object of the invention is also achieved if the whole central areas are rough surfaces. As well, the object of the invention is also achieved if the central area of the readable under-surface of the disc 20 has a plurality of rough passages with respect to the rough passages 24 on the top surface.

One method forms the rough passages 24 by rolling or punching the central area of unfinished compact discs 20 immediately following fabrication, when they are warm and malleable. A second method uses printed ink mesh on the central area 23 to form the rough surfaces. A third method modifies the mold to form rough areas in the central area. In any of these methods, after finishing the injection molding, rough passages 24 are formed on the disc 20.

According to the methods above, a plurality of rough passages 24 can be formed on compact discs 20 of the invention, avoiding vacuum adhesion therebetween.

Second Embodiment

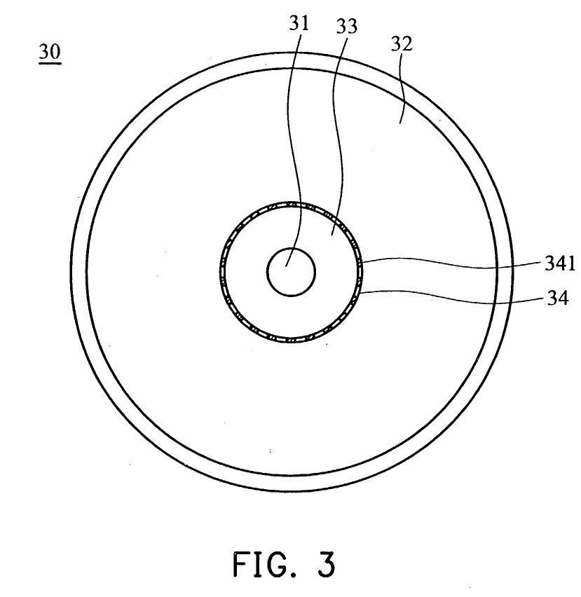

FIG. 3 is a schematic bottom view of the compact disc in the second embodiment. In FIG. 3, the compact disc 30 is an unfinished disc, made by injection molding, of engineering plastic such as Acrylic, PolyCarbonate (PC) or ABS.

The disc 30 has a central hole 31 and a readable under-surface. The readable under-surface of the disc 30 is divided into two areas, a central area 33 and a readable area 32. In order to introduce the laser bean into the data-recording layer without refraction, the readable area 32 must be flat and without abrasion. The central area 33 is an annular area around the through hole 31 on the readable under-surface and has a ring protrusion 34 next to the readable area 32. The ring protrusion 34 is disposed on the readable under-surface, separated from the through hole 31 at a predetermined interval. In this embodiment, a plurality of rough passages 341 is disposed on the ring protrusion 34. The rough passages 341 can be formed by printed ink mesh or punching as described in the first embodiment. Furthermore, another method modifies the mold with respect to the ring protrusion 34 to form rough areas. Thus, after finishing the injection molding, rough passages 341 are formed on the ring protrusion 34 of the disc 30.

When the discs 30 are stacked in a spindle, they thus will not adhere to each other.

Additionally, the first embodiment and the second embodiment can be combined. The discs with rough passages in the central area and on the ring protrusion greatly reduce vacuum adhesion.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A vacuum-resistant compact disc, comprising:
a disc body, having a through hole and a top surface; and
a central area, having a plurality of rough passages disposed between the through hole and the top surface.

2. The vacuum-resistant compact disc as claimed in claim 1, wherein the rough passages are radially disposed in the central area on the top surface.

3. The vacuum-resistant compact disc as claimed in claim 1, wherein the disc body is made by injection molding.

4. The vacuum-resistant compact disc as claimed in claim 1, wherein the rough passages are formed by punching.

5. The vacuum-resistant compact disc as claimed in claim 1, wherein the rough passages are formed by printed ink mesh.

6. A vacuum-resistant compact disc, comprising:
a disc body, having a through hole and a readable under-surface;
a central area, having a ring protrusion disposed on the readable under-surface and separated from the through hole with a predetermined interval; and
a plurality of rough passages, disposed on the ring protrusion.

7. The vacuum-resistant compact disc as claimed in claim 6, wherein the rough passages are radially disposed in the central area on the top surface.

8. The vacuum-resistant compact disc as claimed in claim 6, wherein the disc body is made by injection molding.

9. The vacuum-resistant compact disc as claimed in claim 6, wherein the rough passages are formed by punching.

10. The vacuum-resistant compact disc as claimed in claim 6, wherein the rough passages are formed by printed ink mesh.
